(19) United States
(12) Patent Application Publication
(10) Pub. No.: US 2021/0143871 A1
(43) Pub. Date: May 13, 2021

(54) CONTROLLING POLARIZATION DIVISION MULTIPLEX IN MIMO WIRELESS COMMUNICATION

(71) Applicant: Sony Corporation, Tokyo (JP)

(72) Inventors: Zuleita HO, Lund (SE); Erik BENGTSSON, Eslöv (SE); Kun ZHAO, Stockholm (SE); Fredrik RUSEK, Eslöv (SE)

(21) Appl. No.: 17/259,175

(22) PCT Filed: Jul. 8, 2019
(86) PCT No.: PCT/EP2019/068263

§ 371 Date: Jan. 10, 2021

(30) Foreign Application Priority Data
Jul. 12, 2018 (SE) 1830218-2

(51) Int. Cl. H04B 7/0417; H04W 72/04; H04L 5/00

(52) U.S. Cl. CPC H04B 7/0417; H04L 5/0023; H04W 72/04

(57) ABSTRACT

Methods (10; 30) and devices (20; 40) for controlling polarization division multiplex in a wireless communication network are provided. A method (10) associated with an access node of the wireless communication network comprises: the access node (20) controlling (11A) a first multiple input multiple output, MIMO, transmission between the access node (20) and a first wireless terminal (40, 40A) to use a first set of time-frequency resources, to use a first MEMO spatial channel, and to use a first receive polarization state of the first wireless terminal (40, 40A); and controlling (11B) a second MIMO transmission between the access node (20) and a second wireless terminal (40, 40B) to use a second set of time-frequency resources which at least partially overlaps the first set of time-frequency resources, to use a second MIMO spatial channel which at least partially overlaps the first MIMO spatial channel, and to use a second receive polarization state of the second wireless terminal (40, 40B) which differs from the first receive polarization state.

### FIELD OF THE INVENTION

Various embodiments of the invention relate to methods and devices for controlling polarization division multiplex in a wireless communication network, in particular involving multiple input multiple output, MIMO, wireless transmission.

### BACKGROUND OF THE INVENTION

3GPP 5G standardization associated with spectrum bands in a millimeter wave range, e.g. above 6 GHz, has to deal with challenges such as, for instance, that transmission at these bands suffers from high path losses. This may be overcome by way of MIMO wireless transmission, which enables highly directional beams, or spatial channels, that focus transmitted radio frequency energy.

Establishing such spatial channels in multiple directions enables spatial reuse of time/frequency/code resources. Conventionally, a spatial channel associated with a particular time/frequency/code resource only serves a single user/device.

### BRIEF SUMMARY OF THE INVENTION

In view of the above, there is a need in the art for serving multiple users/devices via a particular spatial channel associated with a particular time/frequency/code resource.

This underlying object of the invention is solved by the methods and devices as defined by the independent claims. Preferred embodiments of the invention are set forth in the dependent claims.

According to a first aspect, a method of controlling radio transmissions in a wireless communication network is provided. The method comprises steps of: an access node of the wireless communication network controlling a first multiple input multiple output, MIMO, transmission between the access node and a first wireless terminal to use a first set of time-frequency resources, to use a first MIMO spatial channel, and to use a first receive polarization state of the first wireless terminal; and the access node controlling a second MIMO transmission between the access node and a second wireless terminal to use a second set of time-frequency resources which at least partially over-laps the first set of time-frequency resources, to use a second MIMO spatial channel which at least partially overlaps the first MIMO spatial channel, and to use a second receive polarization state of the second wireless terminal which differs from the first receive polarization state.

The method may further comprise a step of: the access node detecting a condition of polarization alignment of the first receive polarization state and the second receive polarization state.

The method may further comprise a step of: the access node acquiring first channel state between the access node and the first wireless terminal and second channel state between the access node and the second wireless terminal, the first channel state and the second channel state respectively comprising: a matrix of coupling coefficients, each coupling coefficient of the respective matrix being indicative of a respective power coupling between one of two mutually orthogonal polarization planes of an antenna array of the access node and one of two mutually orthogonal polarization planes of an antenna array of the respective wireless terminal.

The step of the access node acquiring first channel state between the access node and the first wireless terminal and second channel state between the access node and the second wireless terminal may further comprise: receiving a first feedback signal being indicative of the first channel state, and associated with a first training signal transmitted by the access node to the first wireless terminal; and receiving a second feedback signal being indicative of the second channel state and associated with a second training signal transmitted by the access node to the second wireless terminal.

The step of the access node acquiring first channel state between the access node and the first wireless terminal and second channel state between the access node and the second wireless terminal may further comprise: receiving a first training signal being indicative of the first channel state and transmitted by the first wireless terminal; and receiving a second training signal being indicative of the second channel state and transmitted by the second wireless terminal.

The step of the access node detecting a condition of polarization alignment of the first receive polarization state and the second receive polarization state may further comprise: the access node determining that the respective matrix of coupling coefficients of the respective MIMO transmission (i.e., channel matrix including the power coupling between the mutually orthogonal polarization planes of the associated antenna arrays) has a rank of less than two.

The step of the access node detecting a condition of polarization alignment of the first receive polarization state and the second receive polarization state may further comprise: the access node detecting performance degradations of the first MIMO transmission and the second wireless transmission below a performance threshold, the performance degradations arising within a first time limit and persisting for a subsequent second time limit.

The method may further comprise a step of: in response to the access node detecting a condition of polarization alignment of the first receive polarization state and the second receive polarization state: the access node setting a polarization state of at least one of the first MIMO transmission and the second MIMO transmission depending on the first channel state and the second channel state.

The method may further comprise a step of: the access node receiving a signal from at least one of the first wireless terminal and the second wireless terminal being indicative of a corresponding wireless terminal's capability of adjusting its receive polarization state.

The step of the access node setting a polarization state of at least one of the first MIMO transmission and the second MIMO transmission depending on the first channel state and the second channel state may further comprise: the access node signaling at least one of the first receive polarization state to the first wireless terminal and the second receive polarization state to the second wireless terminal depending on the first channel state and the second channel state.

The step of the access node setting a polarization state of at least one of the first MIMO transmission and the second MIMO transmission depending on the first channel state and the second channel state may further comprise: the access node setting at least one of a first transmit polarization state of the first MIMO transmission and a second transmit polarization state of the second MIMO transmission depending on the first channel state and the second channel state, the first transmit polarization state and the first receive polarization state respectively being associated with the first channel state, and the second transmit polarization state and the second receive polarization state respectively being associated with the second channel state.

The step of the access node setting a polarization state of at least one of the first MIMO transmission and the second MIMO transmission depending on the first channel state and the second channel state may further comprise: the access node selecting the first receive polarization state from the eigenvectors of the matrix of coupling coefficients of the first respective MIMO transmission; and the access node selecting the second receive polarization state from the eigenvectors of the matrix of coupling coefficients of the second MIMO transmission, the first receive polarization state and the second receive polarization state particularly being selected such that a total capacity of the first MIMO transmission and the second MIMO transmission is maximized.

According to a second aspect, an access node of a wireless communication network is provided. The access node comprises: a processor being arranged for controlling a first multiple input multiple output, MIMO, transmission between the access node and a first wireless terminal to use a first set of time-frequency resources, to use a first MIMO spatial channel, and to use a first receive polarization state of the first wireless terminal; and controlling a second MIMO transmission between the access node and a second wireless terminal to use a second set of time-frequency resources which at least partially overlaps the first set of time-frequency resources, to use a second MIMO spatial channel which at least partially overlaps the first MIMO spatial channel, and to use a second receive polarization state of the second wireless terminal which differs from the first receive polarization state.

The access node may further comprise: an antenna array having antenna elements being associated with respective ones of two mutually orthogonal polarization planes.

The access node may be arranged for performing the method according to various embodiments.

According to a third aspect, a method of reconfiguring radio transmissions in a wireless communication network is provided. The method comprises steps of: a wireless terminal participating in a multiple input multiple output, MIMO, transmission in a wireless communication network between an access node and the wireless terminal, the MIMO transmission using a set of time-frequency resources, using a MIMO spatial channel, and using a receive polarization state of the wireless terminal; and in response to a trigger to use a different receive polarization state: the wireless terminal participating in the MIMO transmission using the different receive polarization state.

The method may further comprise a step of: the wireless terminal indicating to the access node a capability of adjusting its receive polarization state.

The trigger to use a different receive polarization state may be a signal received from to the access node being indicative of the different receive polarization state.

The trigger to use a different receive polarization state may be a measurement associated with the MIMO transmission being indicative of the different receive polarization state, for example by channel sounding.

The method may further comprise a step of: in response to using a different receive polarization state: the wireless terminal deactivating one of two mutually orthogonal polarization planes of an antenna array of the wireless terminal.

According to a fourth aspect, a wireless terminal is provided. The wireless terminal comprises: a processor being arranged for participating in a multiple input multiple output, MIMO, transmission between an access node of the wireless communication network and the wireless terminal, the MIMO transmission using a set of time-frequency resources, using a MIMO spatial channel, and using a receive polarization state of the wireless terminal; and in response to a trigger to use a different receive polarization state: participating in the MIMO transmission using the different receive polarization state.

The wireless terminal may further comprise: an antenna array having antenna elements being associated with respective ones of two mutually orthogonal polarization planes.

The wireless terminal may be arranged for performing the method according to various embodiments.

### BRIEF DESCRIPTION OF THE DRAWINGS

Embodiments of the invention will be described with reference to the accompanying drawings, in which the same or similar reference numerals designate the same or similar elements.

FIG. 1 illustrates a method 10 of controlling radio transmissions in a wireless communication network by an access node 20 and an interacting method 30 of reconfiguring radio transmissions in a wireless communication network by wireless terminals 40A, 40B.

FIG. 2 illustrates possible variants of the methods 10, 30 of FIG. 1.

FIG. 3 schematically illustrates an access node 20.

FIG. 4 schematically illustrates a wireless terminal 40.

### DETAILED DESCRIPTION OF EMBODIMENTS

Exemplary embodiments of the invention will now be described with reference to the drawings. While some embodiments will be described in the context of specific fields of application, the embodiments are not limited to this field of application. Further, the features of the various embodiments may be combined with each other unless specifically stated otherwise.

The drawings are to be regarded as being schematic representations and elements illustrated in the drawings are not necessarily shown to scale. Rather, the various elements are represented such that their function and general purpose become apparent to a person skilled in the art.

FIG. 1 illustrates a method 10 of controlling radio transmissions in a wireless communication network by an access node 20 and an interacting method 30 of reconfiguring radio transmissions in a wireless communication network by wireless terminals 40A, 40B.

At step 11A of the method 10, the access node 20 of the wireless communication network controls 11A a first multiple input multiple output, MIMO, transmission between the access node 20 and a first wireless terminal 40, 40A to use a first set of time-frequency resources, to use a first MIMO spatial channel, and to use a first receive polarization state of the first wireless terminal 40, 40A.

Correspondingly, at step 31 of the method 30, the first wireless terminal 40A participates 31 in the first MIMO transmission using the first set of time-frequency resources, the first MIMO spatial channel, and the first receive polarization state of the first wireless terminal 40A.

At step 11B of the method 10, the access node 20 controls 11B a second MIMO transmission between the access node 20 and a second wireless terminal 40, 40B to use a second set of time-frequency resources which at least partially overlaps the first set of time-frequency resources, to use a second MIMO spatial channel which at least partially overlaps the first MIMO spatial channel, and to use a second receive polarization state of the second wireless terminal 40, 40B which differs from the first receive polarization state.

Correspondingly, at step 31 of the method 30, the second wireless terminal 40B participates 31 in the second MIMO transmission using the second set of time-frequency resources, the second MIMO spatial channel, and the second receive polarization state of the second wireless terminal 40B.

By maintaining different receive polarization states associated with the MIMO transmissions, two users/devices may be served via a particular spatial channel associated with a particular time/frequency/code resource. In other terms, the method maintains a polarization division multiplex by using waves having different, and ideally mutually orthogonal, polarization states, without requiring additional time/frequency/code resources.

The method can be applied in both downlink and uplink transmission.

In downlink communications, for instance, conventionally different time/frequency/code resources are used to serve multiple users/devices being located in a same (or similar) direction as seen from a serving access node. However, based on polarization division multiplex, multiple users/devices can be served simultaneously without such additional resources. In other terms, the access node may transmit a single beam comprising two MIMO transmissions having different transmit polarization states to serve two users/devices simultaneously. Polarization effects in the spatial channel result in respective receive polarization states at the served devices, which should be different to separate the MIMO transmissions, and ideally mutually orthogonal.

An “access node” as used herein may refer to a serving radio node of a wireless communication network. In particular, the term may refer to a 3G, 4G or 5G base station (typically abbreviated as NB, eNB, or gNB).

A “wireless terminal” as used herein may refer to a mobile device comprising a radio interface by which Wide Area Network, WAN, connectivity to a wireless communication network, in particular to a cellular network, may be established and maintained. Examples for such mobile devices comprise smartphones and computers.

A “wireless communication network” as used herein may refer to a communication network which comprises wireless/radio links between access nodes of the wireless communication network and wireless terminals attached to the wireless communication network, besides fixed network links interconnecting the functional entities of the wireless communication network's infrastructure. Examples for such networks comprise Universal Mobile Telecommunications System, UMTS, and Third Generation Partnership, 3GPP, Long Term Evolution, LTE, cellular networks, New Radio, NR, 5G networks, etc. Generally, various technologies of wireless networks may be applicable and may impart WAN connectivity.

A “time-frequency resource” as used herein may refer to a smallest element of resource allocation assignable by an access node to a wireless terminal being attached to this access node. For instance, a time-frequency resource in LTE downlink communication is defined as a physical resource block, PRB, comprising twelve spectrally consecutive OFDM subcarriers (frequency domain) for a duration of 0.5 ms (time domain). The concept may also be applied to code resources such as those used in CDMA transmission, for example.

“Multiple input multiple output” or “MIMO” as used herein may refer to exploiting multipath propagation between multiple transmit and receive antennas in radio transmission. MIMO wireless transmission may be used to increase transmission capacity, by dividing data into separate streams being transmitted simultaneously over the same air interface. When the individual streams are assigned to different wireless terminals, this is called Multi-User MIMO, MU-MIMO. When the individual streams are assigned to a single wireless terminal, this is called Single-User MIMO, SU-MIMO, and may refer to exploiting multipath propagation in a single link between a transmit phased antenna array and a receive phased antenna array to multiply transmission capacity.

An “antenna array” or a “phased antenna array” as used herein may refer to an antenna array whose antenna elements transmit or receive a plurality of radio waves having relative amplitudes and phases such that a pattern of constructive and destructive interference forms a directional wavefront, i.e., a beam having a particular direction of propagation, without moving the antennas.

A “spatial channel” as used herein may refer to a directional signal transmission (or reception) as a result of controlling (or detecting) a phase and relative amplitude of the signal at each antenna element of a phased antenna array in such a way that signals at particular angles experience constructive interference while others experience destructive interference.

“Polarization” as used herein may refer to a property of a propagating electromagnetic wave, whose associated electric field has a transversal (or perpendicular) oscillation direction with respect to a propagation direction of the wave.

A “polarization plane” as used herein may refer to a property of an antenna element of an antenna or an antenna array. More specifically, the term “polarization plane” may describe a direction of the electric field vector of waves emitted by such an antenna element, or equivalently a direction of the electric field vector of waves incident on such an antenna element which maximizes a reception. For example, cross-polarized antennas or antenna arrays comprise a plurality of antenna elements, and each antenna element is associated with one of two mutually orthogonal polarization planes. The designation as “planes” reflects that the polarization planes of an antenna or an antenna array are typically not subject to change.

A “polarization state” as used herein may refer to a property of an electromagnetic wave. More specifically, the term “polarization state” may describe a direction of an electric field vector of the wave in a plane normal to a propagation direction of the wave. In other terms, the “polarization state” represents an oscillation direction of the electric field of the propagating wave. The designation as a “state” reflects that a polarization state of a wave is subject to change, for instance due to polarization effects in the channel.

A “transmit polarization state” as used herein may refer to a wave's transmit-side polarization state that is constituted through a controlled split of a transmit power onto two mutually orthogonal polarization planes of an antenna array associated with the transmitter. Accordingly, transmit polarization states of MIMO transmissions may be realized by appropriate precoding.

A “receive polarization state” as used herein may refer to a wave's receive-side polarization state that is constituted through a split of the wave's power onto two mutually orthogonal polarization planes of an antenna array associated with the receiver. Receive polarization states of polarization division multiplexed MIMO transmissions must be “different” enough to allow for proper separation and operation of the transmissions: The less mutually orthogonal (i.e., different) the involved MIMO transmissions are in terms of their receive polarization states, the poorer their separation is, resulting in the MIMO transmissions leaking into each other as polarization crosstalk. Accordingly, receive polarization states may be considered “different” enough if the involved MIMO transmissions may still sucessfully be channel decoded after separation. Each wireless terminal may assess this individually for its corresponding MIMO transmission. If both receive polarization states are available in one place, for instance when polarization division multiplexing uplink MIMO transmissions, the receive polarization states may be considered “different” enough if their intermediate angle exceeds a threshold angle.

FIG. 2 illustrates possible variants of the methods 10, 30 of FIG. 1.

The method 10 may further comprise a step of the access node 20 acquiring 12 first channel state between the access node 20 and the first wireless terminal 40, 40A and second channel state between the access node 20 and the second wireless terminal 40, 40B. The first channel state and the second channel state may respectively comprise a matrix of coupling coefficients (i.e., a channel matrix), each coupling coefficient of the respective matrix being indicative of a respective power coupling between one of two mutually orthogonal polarization planes of an antenna array of the access node 20 and one of two mutually orthogonal polarization planes of an antenna array of the respective wireless terminal.

Acquiring channel state for the involved MIMO transmissions enables detecting that polarization-multiplexed transmissions in a same spatial channel align with each other in terms of the receive polarization states.

Acquiring channel state for the involved MIMO transmissions separately enables accurate estimation of the receive polarization states of the respective wireless terminals, since the involved MIMO transmissions may be subject to quite different radio environments, although using a same spatial channel.

“Channel state” as used herein may refer to information describing power coupling between pairs of antenna elements associated with a transmitter and a receiver. Channel state may describe a combined effect of, for example, scattering, fading, and power decay with distance, expressed in terms of a relative phase delay and a relative attenuation. As such, channel state may be considered as a complex-valued channel impulse response. If the involved antenna arrays comprise antenna elements being associated with mutually orthogonal polarization planes, channel state may be generalized to additionally describe power coupling between pairs of antenna elements associated with the different mutually orthogonal polarization planes.

The step of acquiring 12 may further comprise at least one of the following two options:

Firstly, the access node 20 may acquire 12 first and second channel state by receiving 121 a first feedback signal being indicative of the first channel state, and associated with a first training signal transmitted by the access node 20 to the first wireless terminal 40, 40A; and by receiving 121 a second feedback signal being indicative of the second channel state and associated with a second training signal transmitted by the access node 20 to the second wireless terminal 40, 40B. In other terms, the access node 20 may acquire 12 downlink channel state by transmitting respective downlink training signals and receiving feedback as regards the corresponding downlink channel state via the uplink.

Acquiring downlink channel state for the involved MIMO transmissions is a most accurate option for controlling downlink MIMO transmissions, and may also be used for controlling uplink MIMO transmissions if channel reciprocity applies. The training signals may respectively comprise orthogonal vectors in the polarization dimension.

Secondly, the access node 20 may acquire 12 first and second channel state by receiving 122 a first training signal being indicative of the first channel state and transmitted by the first wireless terminal 40, 40A; and by receiving 122 a second training signal being indicative of the second channel state and transmitted by the second wireless terminal 40, 40B. In this case, the access node 20 may acquire 12 uplink channel state by receiving and evaluating uplink training signals transmitted by the respective wireless terminal 40A, 40B.

Acquiring uplink channel state for the involved MIMO transmissions is a most accurate option for controlling uplink MIMO transmissions, and may also be used for controlling downlink MIMO transmissions if channel reciprocity applies. The training signals may respectively comprise orthogonal vectors in the polarization dimension.

A “training signal” as used herein may refer to known channel sounding or pilot signals used for evaluation of radio environments for wireless transmission, especially MIMO transmission. In LTE, for instance, a Sounding Reference Signal, SRS, is used as a training signal transmitted by a wireless terminal to an LTE base station in order to estimate channel state in the uplink direction.

The method 10 may further comprise a step of the access node 20 detecting 13 a condition of polarization alignment of the first receive polarization state and the second receive polarization state.

Detecting that polarization division multiplexed MIMO transmissions in a same spatial channel align with each other in terms of the receive polarization states enables taking countermeasures before such conditions severely affect these MIMO transmissions. For instance, different time-frequency resources and/or different polarization states may be used instead. Although the probability of two wireless terminals having exactly the same receive polarization states in the same time instant is zero, the more the respective receive polarization states are aligned, the more difficult it is to differentiate the polarization division multiplexed MIMO transmissions in general.

The detecting 13 step may further comprise at least one of the following two options:

Firstly, the access node 20 may determine 131 that the respective matrix of coupling coefficients (channel matrix) of the respective MIMO transmission has a rank of less than two. In other terms, the respective channel matrix is ill-ranked.

A rank reduction of the channel matrix may indicate a fundamental transmission impairment such as loss of polarization division multiplex, given the channel matrix also describes power coupling between pairs of antenna elements associated with the different mutually orthogonal polarization planes. If the respective receive polarization states of the involved polarization division multiplexed MIMO transmissions are substantially the same, the channel matrix becomes rank 2 and there is no more degree of freedom to choose the transmit beamforming vectors. A rank of less than two denotes that the involved MIMO transmissions are severely affected in terms of transmission performance (or quality).

A matrix “rank” as used herein may refer to a maximum number of linearly independent rows and/or columns in a matrix. More accurately, the rank of a m×n matrix can be no more than min(m, n).

Secondly, the access node 20 may detect 132 performance degradations of the first MIMO transmission and the second wireless transmission below a performance threshold. The performance degradations of interest arise within a first time limit, and persist for a subsequent second time limit.

A sharply and persisting degradation of transmission performance (or quality) may indicate a breakdown of transmission owing to a fundamental effect such as loss of polarization division multiplex. Channel sounding may be triggered to confirm the suspicion.

A “performance degradation” as used herein may refer to a measurable impairment of transmission performance (or quality), for example in terms of a a digital measure of transmission quality such as a bit error ratio, BER.

The method 30 may further comprise the respective wireless terminal 40A, 40B indicating 32 to the access node 20 a capability of adjusting its receive polarization state.

Correspondingly, the method 10 may further comprise a step of the access node 20 receiving 14 a signal from at least one of the first wireless terminal 40, 40A and the second wireless terminal 40, 40B. The signal is indicative of a corresponding wireless terminal's 40A, 40B capability of adjusting its receive polarization state.

Knowing a respective wireless terminal's 40A, 40B relevant capability provides an access node 20 with an additional degree of freedom for responding to loss of polarization division multiplex besides adapting a precoding, namely adjusting a receive polarization state of said wireless terminal 40A, 40B. Said wireless terminal 40A, 40B, on the other hand, may experience an increased data throughput owing to less (or less intense) channel sounding, which may consume less time-frequency resources.

The method 10 may further comprise a step that in response to the access node 20 detecting 13 a condition of polarization alignment, the access node 20 sets 15 a polarization state of at least one of the first MIMO transmission and the second MIMO transmission depending on the first channel state and the second channel state.

Selectively setting the respective polarization states of the involved MIMO transmissions reduces interference and enables continuing MIMO transmissions to the respective wireless terminal 40A, 40B without extra cost in terms of time-frequency and/or code resources.

The setting 15 step may further comprise at least one of the following two options:

Firstly, the access node 20 may signal 151 at least one of the first receive polarization state to the first wireless terminal 40, 40A and the second receive polarization state to the second wireless terminal 40, 40B depending on the first channel state and the second channel state.

The access node 20 may use the acquired channel state associated with the involved MIMO transmissions to also instruct the corresponding wireless terminals 40A, 40B at which respective receive polarization state a better transmission performance (or quality) can be expected. The corresponding wireless terminals 40A, 40B may use this information to “rotate” by digital signal processing, the received MIMO transmissions to minimize their polarization interference. An optimum transmission performance (or quality) may be expected if the respective receive polarization states are mutually orthogonal. Secondly, the access node 20 may set 152 at least one of a first transmit polarization state of the first MIMO transmission and a second transmit polarization state of the second MIMO transmission depending on the first channel state and the second channel state. The first transmit polarization state and the first receive polarization state are associated with each other via the first channel state, and the second transmit polarization state and the second receive polarization state are associated with each other via the second channel state.

The access node 20 may use the acquired channel state associated with the involved MIMO transmissions to merely adapt a precoding for the involved MIMO transmissions in terms of the corresponding transmit polarization states, and to wait for the corresponding wireless terminals 40A, 40B to adapt to the new precoding, i.e. to the new receive polarization states emerging from the new precoding as described by the respective channel state.

Either of the above two options is capable of triggering the respective wireless terminal to 40A, 40B to use a different receive polarization state, as will be discussed in more detail below.

In addition, the setting 15 step may further comprise a step of the access node 20 selecting 153 the first receive polarization state from the eigenvectors of the matrix of coupling coefficients of the first respective MIMO transmission; and the access node 20 selecting 153 the second receive polarization state from the eigenvectors of the matrix of coupling coefficients of the second MIMO transmission. In particular, the first receive polarization state and the second receive polarization state may be selected such that a total capacity of the first MIMO transmission and the second MIMO transmission is maximized.

Choosing the respective receive polarization state from the eigenvectors of the respective matrix of coupling coefficients (i.e., channel matrix) has the effect that one of the MIMO transmissions uses a null space of the other one of the MIMO transmissions, and vice versa. This results in minimum polarization interference of the polarization division multiplexed MIMO transmissions.

In particular, the selecting 153 step aims at selecting respective receive polarization states for the respective wireless terminals 40A, 40B so that the terminals 40A, 40B may participate 31 in their corresponding MIMO transmissions virtually free of mutual polarization interference, and may even deactivate one of their polarizations/ports individually while still participating 31 in the corresponding MIMO transmission.

Transmit signals x₁ and x₂ are sent at the two mutually orthogonal polarization planes associated with an antenna array 22 of the access node 20.

Channel matrix H comprises coupling coefficients h₁₁, h₁₂, h₂₁ and h₂₂ describe signal propagation of the transmit signals x₁ and x₂.

In absence of noise, receive signals y₁₁ and y₁₂ are received at the first wireless terminal 40A, and receive signals y₂₁ and y₂₂ are received at the second wireless terminal 40B:

$$[ \begin{matrix}{y}_{11} \\ {y}_{12} \\ {y}_{21} \\ {y}_{22}\end{matrix} ] = [ \begin{matrix}{h}_{11} & {h}_{12} \\ {h}_{21} & {h}_{22} \\ {h}_{31} & {h}_{32} \\ {h}_{41} & {h}_{42}\end{matrix} ] [ \begin{matrix}{x}_{1} \\ {x}_{2}\end{matrix} ] = [ \begin{matrix}{h}_{11} & {h}_{12} \\ {h}_{21} & {h}_{22} \\ {h}_{31} & {h}_{32} \\ {h}_{41} & {h}_{42}\end{matrix} ] ( {f}_{1} {a}_{1} + {f}_{2} {a}_{2} )$$

Precoding vectors f₁ and f₂ map data streams a₁ and a₂ to the polarization dimension. In other terms, the transmit polarization states of the involved MIMO transmissions are defined by precoding.

For polarization division multiplexed MIMO transmissions virtually free of mutual polarization interference, diversity, or ideally orthogonality, of the involved receive polarization states is required. Orthogonality is achieved in any one of four cases:
1) [h₁₁h₁₂]f₂=0\hat{ }[h₃₁h₃₂]f₁=0
2) [h₁₁h₁₂]f₂=0\hat{ }[h₄₁h₄₂]f₁=0
3) [h₂₁h₂₂]f₂=0\hat{ }[h₃₁h₃₂]f₁=0
4) [h₂₁h₂₂]f₂=0\hat{ }[h₄₁h₄₂]f₁=0

In any of these cases, either of the wireless terminals 40A, 40B has an interference-free receive signal. For example, if the requirements of case 1) above are satisfied, receive signal y₁₁ of the first wireless terminal 40A has no contribution of data stream a₂ intended for the second wireless terminal 40B , and receive signal y₂₁ the second wireless terminal 40B has no contribution of data stream al intended for the first wireless terminal 40A. Similar considerations apply for the other cases 2)-4).

Given these four ways to minimize polarization interference, it is desirable to select the one that maximizes a total capacity of the involved MIMO transmissions. At high signal-to-noise ratio, SNR, the ensuing capacity from each case 1)-4) is determined by the below quantities:

$$Let G = {HH}^{H} \text{:}$$

$$\begin{matrix}\frac{{G}_{11} {G}_{33} - {\vert {G}_{13} \vert}^{2}}{\sqrt{{G}_{11} {G}_{33}}} & 1 ) \\ \frac{{G}_{11} {G}_{44} - {\vert {G}_{14} \vert}^{2}}{\sqrt{{G}_{11} {G}_{44}}} & 2 ) \\ \frac{{G}_{22} {G}_{33} - {\vert {G}_{23} \vert}^{2}}{\sqrt{{G}_{22} {G}_{33}}} & 3 ) \\ \frac{{G}_{22} {G}_{44} - {\vert {G}_{24} \vert}^{2}}{\sqrt{{G}_{22} {G}_{44}}} & 4 )\end{matrix}$$

After determining the largest value of the four quantities provided above, the corresponding precoding vectors f₁ and f₂ may be determined. If both wireless terminals 40A, 40B have an interference-free receive signal, matrix G has a size of 2×2 and has two eigenvalues associated with orthogonal eigenvectors. Performing a MIMO transmission along those eigenvectors (or actually any orthogonal vectors) to one of the wireless terminals 40A, 40B means using a null space of the MIMO transmission to the other one of the wireless terminals 40A, 40B.

Thus, the precoding vectors f₁ and f₂ may be determined by computing null-spaces as known in the art, and configured/set at the transmit side. This is equivalent to rotating the corresponding transmit polarization states so that the respective MIMO transmissions become mutually orthogonal.

The resulting precoding vectors enable two users/devices to enjoy virtually interference-free MIMO transmission (i.e., free of interference by the other MIMO transmission).

In response to a trigger to use a different receive polarization state by the access node 20, the respective wireless terminal 40A, 40B may continue to participate 31 in its respective MIMO transmission using the different receive polarization state.

The trigger to use a different receive polarization state may be a signal received from to the access node 20 being indicative of the different receive polarization state, or a measurement associated with the MIMO transmission being indicative of the different receive polarization state, for example by channel sounding.

The method 10 may further comprise a step of: in response to using a different receive polarization state, the respective wireless terminal 40A, 40B deactivating 33 one of two mutually orthogonal polarization planes of its antenna array 42.

A wireless terminal that is subject to minimized polarization interference by using a different receive polarization state may only need to operate one of the two mutually orthogonal polarization planes of its antenna array, which means one port of the wireless terminal's receiver can be switched off to reduce energy consumption by up to 50%. Alternatively or additionally, the access node may indicate to the wireless terminals which polarization/port should be used.

In case of wireless terminals 40, 40A, 40B comprising an antenna array 42 having only a single polarization plane, it is conceivable that the access node 20 sets 152 a corresponding transmit polarization state (i.e., defines a precoding) to match the wireless terminal's 40 optimum receive polarization state.

FIG. 3 schematically illustrates an access node 20.

The access node 20 comprises a processor 21 being arranged for controlling 11A a first multiple input multiple output, MIMO, transmission between the access node 20 and a first wireless terminal 40, 40A to use a first set of time-frequency resources, to use a first MIMO spatial channel, and to use a first receive polarization state of the first wireless terminal 40, 40A. The processor 21 is further arranged for controlling 11B a second MIMO transmission between the access node 20 and a second wireless terminal 40, 40B to use a second set of time-frequency resources which at least partially overlaps the first set of time-frequency resources, to use a second MIMO spatial channel which at least partially overlaps the first MIMO spatial channel, and to use a second receive polarization state of the second wireless terminal 40, 40B which differs from the first receive polarization state. The access node 20 may further comprise an antenna array 22 having antenna elements being associated with respective ones of two mutually orthogonal polarization planes, and may be arranged for performing the method 10 according to embodiments.

The technical effects and advantages described above in relation with the method 10 of controlling radio transmissions in a wireless communication network equally apply to the access node 20 having corresponding features.

FIG. 4 schematically illustrates a wireless terminal 40.

The wireless terminal 40, 40A, 40B comprises a processor 41 being arranged for participating 31 in a multiple input multiple output, MIMO, transmission between an access node 20 of the wireless communication network and the wireless terminal 40, 40A, 40B, the MIMO transmission using a set of time-frequency resources, using a MIMO spatial channel, and using a receive polarization state of the wireless terminal 40, 40A, 40B. In response to a trigger to use a different receive polarization state, the processor is further arranged for participating 31 in the MIMO transmission using the different receive polarization state. The wireless terminal 40, 40A, 40B may further comprise an antenna array 42 having antenna elements being associated with respective ones of two mutually orthogonal polarization planes, and may be arranged for performing the method according to embodiments.

The technical effects and advantages described above in relation with the method 30 of reconfiguring radio transmissions in a wireless communication network equally apply to the wireless terminal 40 having corresponding features.

The present invention may, of course, be carried out in other ways than those specifically set forth herein without departing from essential characteristics of the invention. For example, the previous embodiments described the present invention in downlink radio communication. However, those skilled in the art will appreciate that the present invention is not so limited. The present invention may also be used in uplink radio communications as well. The present embodiments are therefore to be considered in all respects as illustrative and not restrictive, and all changes coming within the meaning and equivalency range of the appended claims are intended to be embraced therein.

1. A method of controlling radio transmissions in a wireless communication network, the method comprising:
an access node of the wireless communication network controlling a first multiple input multiple output, MIMO, transmission between the access node and a first wireless terminal
to use a first set of time-frequency resources,
to use a first MIMO spatial channel, and
to use a first receive polarization state of the first wireless terminal;
the access node controlling a second MIMO transmission between the access node and a second wireless terminal
to use a second set of time-frequency resources which at least partially overlaps the first set of time-frequency resources,
to use a second MIMO spatial channel which at least partially overlaps the first MIMO spatial channel, and
to use a second receive polarization state of the second wireless terminal which differs from the first receive polarization state
the access node detecting a condition of polarization alignment of the first receive polarization state and the second receive polarization state;
the access node receiving a signal from at least one of the first wireless terminal and the second wireless terminal being indicative of a corresponding wireless terminal's capability of adjusting its receive polarization state; and
in response to the detecting: the access node setting a polarization state of at least one of the first MIMO transmission and the second MIMO transmission depending on the first channel state and the second channel state.

2. The method of claim 1, further comprising
the access node acquiring first channel state between the access node- and the first wireless terminal and second channel state between the access node and the second wireless terminal, the first channel state and the second channel state respectively comprising: a matrix of coupling coefficients, each coupling coefficient of the respective matrix being indicative of a respective power coupling between one of two mutually orthogonal polarization planes of an antenna array of the access node and one of two mutually orthogonal polarization planes of an antenna array of the respective wireless terminal; wherein the setting comprises:
the access node selecting, the first receive polarization state from the eigenvectors of the matrix of coupling coefficients of the first respective MIMO transmission and the second receive polarization state from the eigenvectors of the matrix of coupling coefficients of the second MIMO transmission, the selecting comprising:
the access node selecting, in accordance with a product of a channel matrix, one of a plurality of interference-free transmission modes such that a total capacity of the first MIMO transmission and the second MIMO transmission is jointly maximized; and
the access node determining, in accordance with the channel matrix respective precoding vectors for the first and second MIMO transmissions corresponding to the selected one of the plurality of transmission modes;
wherein the channel matrix comprises the matrices of coupling coefficients- of the first and second MIMO transmissions.

3. The method of claim 2, wherein
the access node acquiring first channel state between the access node- and the first wireless terminal and second channel state between the access node and the second wireless terminal further comprises:
receiving a first feedback signal being indicative of the first channel state, and associated with a first training signal transmitted by the access node to the first wireless terminal; and
receiving a second feedback signal being indicative of the second channel state and associated with a second training signal transmitted by the access node to the second wireless terminal.

4. The method of claim 2, wherein
the access node acquiring first channel state between the access node- and the first wireless terminal and second channel state between the access node and the second wireless terminal further comprises:
receiving a first training signal being indicative of the first channel state and transmitted by the first wireless terminal; and
receiving a second training signal being indicative of the second channel state and transmitted by the second wireless terminal.

5. The method of claim 2, wherein
the access node detecting a condition of polarization alignment of the first receive polarization state and the second receive polarization state further comprises:
the access node determining that the respective matrix of coupling coefficients of the respective MIMO transmission has a rank of less than two.

6. The method of claim 1, wherein
the access node detecting a condition of polarization alignment of the first receive polarization state and the second receive polarization state further comprises:
the access node detecting performance degradations of the first MIMO transmission and the second wireless transmission below a performance threshold, the performance degradations arising within a first time limit and persisting for a subsequent second time limit.

7. The method of claim 1, wherein:
the access node setting a polarization state of at least one of the first MIMO transmission and the second MIMO transmission depending on the first channel state and the second channel state further comprises:
the access node signaling at least one of the first receive polarization state to the first wireless terminal and the second receive polarization state to the second wireless terminal depending on the first channel state and the second channel state.

8. An access node of a wireless communication network, the access node comprising
a processor being arranged for
controlling a first multiple input multiple output, MIMO, transmission between the access node and a first wireless terminal
to use a first set of time-frequency resources,
to use a first MIMO spatial channel, and
to use a first receive polarization state of the first wireless terminal;
controlling a second MIMO transmission between the access node and a second wireless terminal
to use a second set of time-frequency resources which at least partially overlaps the first set of time-frequency resources,
to use a second MIMO spatial channel which at least partially overlaps the first MIMO spatial channel, and
to use a second receive polarization state of the second wireless terminal which differs from the first receive polarization state;
detecting a condition of polarization alignment of the first receive polarization state and the second receive polarization state;
receiving a signal from at least one of the first wireless terminal and the second wireless terminal being indicative of a corresponding wireless terminal's capability of adjusting its receive polarization state; and
in response to the detecting: setting a polarization state of at least one of the first MIMO transmission and the second MIMO transmission depending on the first channel state and the second channel state.

9. The access node of claim 8,
the processor being further arranged for
acquiring first channel state between the access node and the first wireless terminal and second channel state between the access node and the second wireless terminal, the first channel state and the second channel state respectively comprising: a matrix of coupling coefficients, each coupling coefficient of the respective matrix being indicative of a respective power coupling between one of two mutually orthogonal polarization planes of an antenna array of the access node and one of two mutually orthogonal polarization planes of an antenna array of the respective wireless terminal;
wherein the setting comprises:
selecting the first receive polarization state from the eigenvectors of the matrix of coupling coefficients of the first respective MIMO transmission and the second receive polarization state from the eigenvectors of the matrix of coupling coefficients of the second MIMO transmission, wherein the selecting comprises:
selecting, in accordance with a product of a channel matrix, one of a plurality of interference-free transmission modes such that a total capacity of the first MIMO transmission and the second MIMO transmission is jointly maximized; and
determining, in accordance with the channel matrix, respective precoding vectors for the first and second MIMO transmissions corresponding to the selected one of the plurality of transmission modes;
wherein the channel matrix comprises the matrices of coupling coefficients- of the first and second MIMO transmissions.

10. The access node of claim 8, further comprising:
an antenna array having antenna elements being associated with respective ones of two mutually orthogonal polarization planes.

11. (canceled)

12. A method of reconfiguring radio transmissions in a wireless communication network, comprising:
a wireless terminal participating in a multiple input multiple output, MIMO, transmission in a wireless communication network between an access node and the wireless terminal, the MIMO transmission
using a set of time-frequency resources,
using a MIMO spatial channel, and
using a receive polarization state of the wireless terminal;
the wireless terminal indicating to the access node a capability of adjusting its receive polarization state;
in response to a trigger to use a different receive polarization state: the wireless terminal participating in the MIMO transmission
using the different receive polarization state.

13. The method of claim 12, further comprising
in response to using the different receive polarization state: the wireless terminal-deactivating one of two mutually orthogonal polarization planes of an antenna array of the wireless terminal.

14. The method of claim 12, wherein:
the trigger to use a different receive polarization state is a signal received from to the access node being indicative of the different receive polarization state.

15. The method of claim 12, wherein:
the trigger to use a different receive polarization state is a measurement associated with the MIMO transmission being indicative of the different receive polarization state.

16. A wireless terminal, comprising:
a processor being arranged for
participating in a multiple input multiple output, MIMO, transmission between an access node of the wireless communication network and the wireless terminal-, the MIMO transmission
using a set of time-frequency resources,
using a MIMO spatial channel, and
using a receive polarization state of the wireless terminal;
indicating to the access node a capability of adjusting its receive polarization state;
in response to a trigger to use a different receive polarization state: participating- in the MIMO transmission
using the different receive polarization state.

17. The wireless terminal of claim 16, further comprising:
an antenna array having antenna elements being associated with respective ones of two mutually orthogonal polarization planes;
the processor further being arranged for
in response to using the different receive polarization state: deactivating one of the two mutually orthogonal polarization planes of the antenna array.

18. (canceled)
